(19) United States
(12) Patent Application Publication
(10) Pub. No.: US 2016/0062929 A1
(43) Pub. Date: Mar. 3, 2016

(54) MASTER DEVICE, SLAVE DEVICE AND COMPUTING METHODS THEREOF FOR A CLUSTER COMPUTING SYSTEM

(71) Applicant: INSTITUTE FOR INFORMATION INDUSTRY, Taipei (TW)

(72) Inventors: Chi-Tien YEH, Taichung City (TW); Xing-Yu CHEN, Tianzhong Township (TW); Yuh-Jye LEE, Taipei City (TW); Hsing-Kuo PAO, New Taipei City (TW)

(21) Appl. No.: 14/518,411

(22) Filed: Oct. 20, 2014

(30) Foreign Application Priority Data
Aug. 27, 2014 (TW) 103129437

(51) Int. Cl. G06F 13/364; G06F 17/30

(52) U.S. Cl. CPC G06F 13/364; G06F 17/30194

(57) ABSTRACT

A master device, a slave device and computing methods thereof for a cluster computing system are provided. The master device is configured to receive device information of the slave device, select a resource feature model for the slave device according to the device information and a job, estimate a container configuration parameter of the slave device according to the resource feature model, transmit the container configuration parameter to the slave device, and assign the job to the slave device. The slave device is configured to transmit the device information to the master device, receive the job assigned by the master device with the container configuration parameter from the master device, generate at least one container to compute the job according to the container configuration parameter, and generate the resource feature model according to job information corresponding to the job and a metric file.

### PRIORITY

This application claims priority to Taiwan Patent Application No. 103129437 filed on Aug. 27, 2014, which is hereby incorporated herein by reference in its entirety.

### FIELD

The present invention relates to a master device, a slave device and computing methods thereof. More particularly, the present invention relates to a master device, a slave device and computing methods thereof for a cluster computing system.

### BACKGROUND

For big data computations, cluster computing technologies are effective solutions. Generally, cluster computing means that a plurality of computing units are clustered to accomplish a job through the cooperation of these computing units. In operation, a cluster computing system usually comprises a master device and a plurality of slave devices. The master device is configured to assign a job to the slave devices. Each of the slave devices is configured to generate containers for performing the assigned tasks corresponding to the job. Therefore, to avoid waste, resources must be allocated appropriately by the cluster computing system for big data computations.

Commonly, the conventional cluster computing system might be unable to effectively allocate resources due to the following problems. Firstly, the containers generated by the conventional slave devices all have fixed specifications (including the central processing unit (CPU) specification and the memory specification), so resource waste is caused by the different properties of different jobs. For example, when the computational demand of a job is lower than the specification of a container, resource waste may happen due to incomplete utilization of the container. Furthermore, because the container specification is fixed for each of the containers, the number of containers that can be generated by a conventional slave device is also fixed, so the resources are idled. For example, when the number of containers necessary for a job is smaller than the total number of containers, the idling of resources will lead to an excessive number of containers. Additionally, because the container specification is fixed for each of the containers, the improper allocation of resources tends to occur when a plurality of slave devices have different device performances. For example, when two slave devices have the same container specification but have different device performances, improper allocation of resources will result due to different processing efficiencies of the two slave devices.

Accordingly, it is important to provide an effective resource allocation technology for conventional cluster computing systems in the art.

### SUMMARY

An objective of the present invention includes providing an effective resource allocation technology for conventional cluster computing systems.

To achieve the aforesaid objective, certain embodiments of the present invention include a master device for a cluster computing system. The master device comprises a connection interface and a processor. The connection interface is configured to connect with at least one slave device. The processor is electrically connected to the connection interface, and is configured to receive device information from the slave device, select a resource feature model for the slave device according to the device information and a job, estimate a container configuration parameter of the slave device according to the resource feature model, transmit the container configuration parameter to the slave device, and assign the job to the slave device.

To achieve the aforesaid objective, certain embodiments of the present invention include a slave device for a cluster computing system. The slave device comprises a connection interface and a processor. The connection interface is configured to connect with a master device. The processor is electrically connected to the connection interface, and is configured to transmit device information to the master device, receive a job and a container configuration parameter that are assigned by the master device from the master device, generate at least one container to compute the job according to the container configuration parameter, and create a resource feature model according to job information corresponding to the job and a metric file.

To achieve the aforesaid objective, certain embodiments of the present invention include a computing method for a master device in a cluster computing system. The master device comprises a connection interface and a processor. The connection interface is configured to connect with at least one slave device. The computing method comprises the following steps:
(A) receiving device information of the slave device by the processor;
(B) selecting a resource feature model for the slave device according to the device information and a job by the processor;
(C) estimating a container configuration parameter of the slave device according to the resource feature model by the processor;
(D) transmitting the container configuration parameter to the slave device by the processor; and
(E) assigning the job to the slave device by the processor.

To achieve the aforesaid objective, certain embodiments of the present invention include a computing method for a slave device in a cluster computing system. The slave device comprises a connection interface and a processor. The connection interface is configured to connect with a master device. The computing method comprises the following steps:
(A) transmitting device information to the master device by the processor;
(B) receiving a job and a container configuration parameter that are assigned by the master device from the master device by the processor;
(C) generating at least one container to compute the job according to the container configuration parameter by the processor; and
(D) creating a resource feature model by the processor according to job information corresponding to the job and a metric file.

According to the above descriptions, the present invention, in certain embodiments, provides a master device, a slave device and computing methods thereof for a cluster computing system. A master device receives device information transmitted by each of the slave devices, selects a resource feature model for each of the slave devices according to the device information and a job, estimates a container configuration parameter of the corresponding slave device according to each of the resource feature models, transmits each of the container configuration parameters to the corresponding slave device, and assigns the job to the slave devices. A slave device transmits device information thereof to a master device, receives a job and a container configuration parameter assigned by the master device from the master device, generates at least one container to compute the job according to the container configuration parameter, and creates a resource feature model according to job information corresponding to the job and a metric file.

Accordingly, the specification of the containers generated by the slave device of the present invention can be adjusted dynamically, so there would be no resource in waste due to different properties of different jobs. Furthermore, because the container specification is not fixed for each of the containers of the present invention, the number of containers of the slave device of the present invention can also be adjusted dynamically, so there would be no resource idling. Additionally, because the container specification and the number of the containers generated by the slave device of the present invention can be adjusted dynamically, improper allocation of resources will not occur even when a plurality of slave devices have different device performances.

The detailed technology and preferred embodiments implemented for the subject invention are described in the following paragraphs accompanying the appended drawings for persons skilled in this field to well appreciate the features of the claimed invention.

### BRIEF DESCRIPTION OF THE DRAWINGS

A brief description of drawings are made as the following, but this is not intended to limit the present invention.

FIG. 1 is a schematic structural view of a cluster computing system according to an embodiment of the present invention.

FIG. 2 is a schematic view illustrating the operations of a master device and a single slave device in the cluster computing system shown in FIG. 1.

FIG. 3 is a schematic view illustrating the operations of an optimal resource module in the master device shown in FIG. 2.

FIG. 4 is a schematic view illustrating the operations of a model manager in the master device shown in FIG. 2.

FIG. 5 is a schematic view illustrating the operations of a model generator in the slave device shown in FIG. 2.

FIG. 6 is a schematic view illustrating the operations of a job status collector in the slave device shown in FIG. 2.

FIG. 7 is a schematic view illustrating a computing method for a master device and a slave device in a cluster computing system according to an embodiment of the present invention.

### DETAILED DESCRIPTION

The present invention will be explained with reference to example embodiments thereof. However, the following example embodiments are not intended to limit the present invention to any specific examples, embodiments, environments, applications, structures, process flows, or steps as described in these embodiments. In other words, the description of the following example embodiments is only for the purpose of explaining the present invention rather than to limit the present invention.

In the drawings, elements not directly related to the present invention are all omitted from depiction; and dimensional relationships among individual elements in the drawings are illustrated only for ease of understanding but not to limit the actual scale.

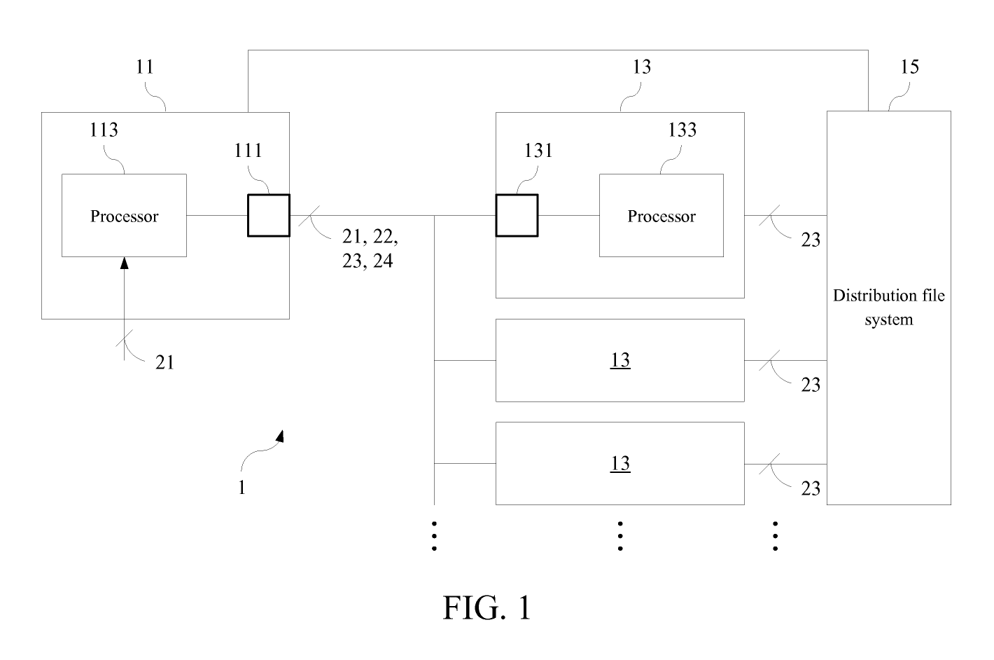

An embodiment of the present invention (briefly called “a first embodiment”) is a cluster computing system. FIG. 1 is a schematic structural view of the cluster computing system. As shown in FIG. 1, the cluster computing system 1 may comprise a master device 11 and at least one slave device 13 (i.e., one or a plurality of slave devices). The master device may comprise a connection interface 111 and a processor 113, which may be electrically connected with each other directly or indirectly and communicate with each other. Each of the slave devices 13 may comprise a connection interface 131 and a processor 133, which may be electrically connected with each other directly or indirectly and communicate with each other. The connection interface 111 of the master device 11 may be connected with and communicate with the connection interface 111 of each of the slave devices 13 via various media (not shown). The connection interface 111 of the master device 11 may be connected with and communicate with the connection interface 111 of each of the slave devices 13 in various wired or wireless ways depending on different media (e.g., networks, buses and etc.). Each of the master devices 11 and the slave devices 13 may be a standalone computer, or a standalone computing unit in a computer.

The cluster computing system 1 may optionally comprise a distribution file system 15. The distribution file system 15 is a file system that is formed by the plurality of slave devices 13; each providing a part of resources (e.g., storage spaces). The distribution file system 15 is shared by the master device 11 and the slave devices 13. Specifically, through the connections between the connection interface 111 of the master device 11 and the connection interfaces 131 of the slave devices 13, the master device 11 and each of the slave devices 13 can access the data in the distribution file system 15. In other words, the master device 11 and each of the slave devices 13 can store data into the distribution file system 15, and can also read data from the distribution file system 15. Optionally, the master device 11 may also directly access the data in the distribution file system 15 via other interfaces or in other manners.

As shown in FIG. 1, when the cluster computing system 1 is to compute a job 21 (e.g., an algorithm), the master device 11 may request the slave device 13 to transmit device information 22 thereof to the master device 11. Alternatively, the slave device 13 may transmit the device information 22 thereof to the master device 11 periodically. More specifically, each of the slave devices 13 can transmit the device information 22 thereof to the master device 11 via the connection interface 131 thereof. The master device 11 can receive the device information 22 transmitted by each of the slave devices 13 via the connection interface 111 thereof. Therefore, when the cluster computing system 1 is to compute a job 21, the processor 113 of the master device 11 may acquire the device information 22 transmitted by all the slave devices 13 beforehand. The job 21 may be generated by the master device 11 itself, or may also be inputted by other devices outside the master device. The device information 22 of the slave device 13 may comprise information about the hardware, the software, and the computing capability thereof.

After having acquired the device information 22 transmitted by all the slave devices 13, the processor 113 of the master device 11 may select a resource feature model 23 for each of the corresponding slave device 13 according to the device information 22 and the job 21. Each of the resource feature models 23 may comprise, as needed, any of various feature models such as, but not limited to, a central processing unit (CPU) feature model, a memory feature model, a network feature model, a disk input and out (Disk IO) feature model and etc. The CPU feature model may be used to estimate a CPU specification necessary for a container computing a job. The memory feature model may be used to estimate a memory specification necessary for the container computing the job. The network feature model may be used to estimate a network specification necessary for the container computing the job. The Disk IO feature model may be used to estimate a Disk IO specification necessary for the container computing the job.

If the cluster computing system 1 comprises a distribution file system 15, the processor 113 of the master device 11 can select the resource feature model 23 for each of the slave devices 13 from the distribution file system 15. For example, the distribution file system 15 may store a plurality of resource feature model samples beforehand. The processor 113 of the master device 11 can select the resource feature model 23 for each of the slave devices 13 from the resource feature model samples according to the corresponding device information 22 and the job 21.

If the cluster computing system 1 does not comprise the distribution file system 15, the processor 113 of the master device 11 may also select the resource feature model 23 for each of the slave devices 13 according to the resource feature model samples provided by other sources. For example, the master device 11 may comprise a storage device (not shown) for storing a plurality of resource feature model samples beforehand, or acquire the plurality of resource feature model samples from other devices beforehand. The processor 113 of the master device 11 can select the resource feature model 23 for each of the slave devices 13 from the resource feature model samples according to the corresponding device information 22 and the job 21. The aforesaid resource feature model samples may be the resource feature model 23 itself or information related to it.

If the number of the resource feature model samples that can be acquired is too large (e.g., larger than a threshold value), then no matter whether the cluster computing system 1 comprises the distribution file system 15 or not, the processor 113 of the master device 11 may optionally classify the plurality of resource feature model samples into a plurality of groups and select a resource feature model sample from each of the groups as a resource feature model representative. For example, the processor 113 of the master device 11 can classify the plurality of resource feature model samples into a plurality of groups by using the K-means algorithm. Then, the processor 113 of the master device 11 can select the resource feature model 23 for each of the slave devices 13 from the resource feature model representatives according to the corresponding device information 22 and the job 21. The aforesaid resource feature model samples may be the resource feature model 23 itself or information related to it.

The processor 113 of the master device 11 can select one of a corresponding resource feature model, a similar resource feature model and a preset resource feature model as the resource feature model 23 for each of the slave devices 13 according to the corresponding device information 22 and the job 21. The corresponding resource feature model is selected with a priority over the similar resource feature model, and the similar resource feature model is selected with a priority over the preset resource feature model. Specifically, for each of the slave devices 13, the processor 113 of the master device 11 can firstly determine whether there is a corresponding resource feature model (i.e., a resource feature model completely corresponding to the device information 22 and the job 21) according to the corresponding device information 22 and the job 21. If the determination result is “yes”, the processor 113 of the master device 11 selects the corresponding resource feature model as the resource feature model 23. If the determination result is “no”, the processor 113 of the master device 11 determines whether there is a similar resource feature model (i.e., a resource feature model similarly corresponding to the device information 22 and the job 21) according to the corresponding device information 22 and the job 21. If the determination result is “yes”, the processor 113 of the master device 11 selects the similar resource feature model as the resource feature model 23. If the determination result is no, the processor 113 of the master device 11 selects a preset resource feature model (i.e., a resource feature model that is preset) as the resource feature model 23.

The processor 113 of the master device 11 can estimate a container configuration parameter 24 of the corresponding slave device 13 according to each of the resource feature models 23. Each of the container configuration parameters 24 may comprise a container number and a container specification; and each of the container specifications may comprise, as needed, any of various specifications such as, but not limited to, a CPU specification, a memory specification, a network specification, a disk input and output (Disk TO) specification and etc. Specifically, the processor 113 of the master device 11 can, according to each of the resource feature models 23, estimate various specifications (e.g., a CPU specification, a memory specification, a network specification, a Disk IO specification and etc.) necessary for the corresponding slave device 13 to open a container for the computation of the job 21. Then, the processor 113 of the master device 11 can estimate the number of containers that needs to be opened by the slave device 13 according to the device information 22 of the slave device 13 and the estimated specifications (e.g., the CPU specification, the memory specification, the network specification, the Disk TO specification and etc.).

For example, if the processor 113 of the master device 11 estimates that a CPU specification and a memory specification necessary for a slave device 13 to open a container for the computation of the job 21 are one gigahertz (1 GHz) and one gigabyte (1 GB) respectively, and the device information 22 indicates that the CPU capability and the memory capability of the slave device 13 are four gigahertz (4 GHz) and four gigabyte (4 GB) respectively, then the processor 113 of the master device 11 estimates that the number of containers necessary for the slave device 13 to compute the job 21 is four.

The processor 113 of the master device 11 may transmit each of the container configuration parameters 24 to the corresponding slave device 13 via the connection interface 111, and assign the job 21 to these slave devices. If the cluster computing system 1 has only a single available slave device 13 therein, then the job 21 will be computed by the single slave device 13 alone. If the cluster computing system 1 has a plurality of available slave devices 13 therein, then the job 21 will be computed by these slave devices 13 together. In the latter case, the processor 113 of the master device 11 will divide the job 21 into a plurality of tasks and then assign these tasks to these slave devices 13. The method in which to divide the job 21 into a plurality of tasks and assign the tasks to the plurality of slave devices 13 is well known to those of ordinary skill in the art, and this will not be further described herein.

The processor 133 of each of the slave devices 13 can receive the job 21 assigned by the master device 11 (or tasks corresponding to the job 21 assigned by the master device) and the corresponding container configuration parameter 24 via the connection interface 131. Then, the processor 133 of each of the slave devices 13 can generate at least one container to compute the job 21 (or the tasks corresponding to the job 21 assigned by the master device) according to the received container configuration parameter 24. In the cluster computing system 1, each of the slave devices 13 has a metric file for storing various local data. Therefore, during the process of computing the job 21 (or the tasks corresponding to the job 21 assigned by the master device) by the at least one container, the processor 133 of the slave device 13 can collect a job status of the at least one container and store status information of the job status into the metric file.

After the computation of the job 21 (or the tasks corresponding to the job 21 assigned by the master device) is accomplished, the processor 133 of each of the slave devices 13 can create a resource feature model 23 according to job information corresponding to the job 21 and the metric file thereof. For example, the processor 133 of each of the slave devices 13 can use a Support Vector Regression (SVR) module generator to create a resource feature model according to the job information corresponding to the job 21 and the metric file thereof. As described above, the resource feature model 23 may comprise, as needed, any of various feature models such as, but not limited to, a CPU feature model, a memory feature model, a network feature model, a disk input and output (Disk IO) feature model and etc.

If the cluster computing system 1 comprises the distribution file system 15, the processor 113 of the master device 11 can store the job information corresponding to the job 21 into the distribution file system 15 beforehand, and the processor 133 of each of the slave devices 13 can acquire the job information corresponding to the job 21 from the distribution file system 15.

If the cluster computing system 1 does not comprise the distribution file system 15, the processor 133 of each of the slave devices 13 may also acquire the job information corresponding to the job 21 in other ways. As an example, the processor 133 of each of the slave devices 13 may acquire the job information corresponding to the job 21 from the master device 11 via the connection interface 131 and the connection interface 111. As another example, each of the slave devices 13 may comprise a storage (not shown) for storing the job information corresponding to the job 21 beforehand, or acquire the job information corresponding to the job 21 from other devices beforehand.

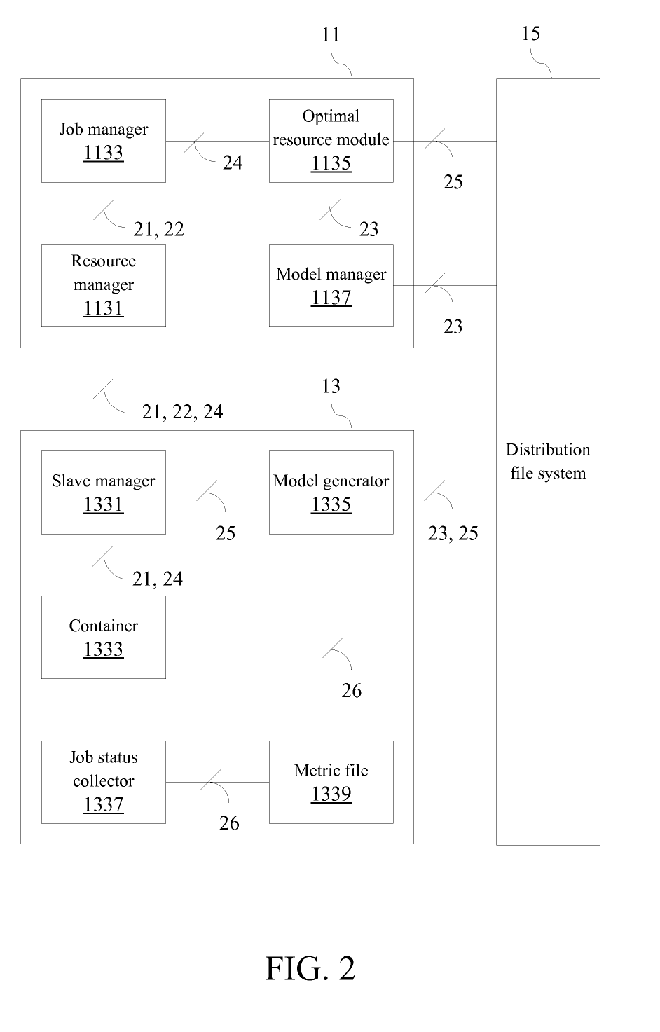

For those of ordinary skill in the art of the present invention, the interactions between the master device 11 and the plurality of slave devices 13 can be known by analogy, so FIG. 2 will be taken as an exemplary example of this embodiment to further describe the interactions between the master device 11 and a single slave device 13 in the cluster computing system 1. However, this is only for ease of illustration rather than to limit the present invention. FIG. 2 is a schematic view illustrating the operations of the master device 11 and the single slave device 13 in the cluster computing system 1. The slave device 13 shown in FIG. 2 may be any of the plurality of slave devices 13 shown in FIG. 1.

As shown in FIG. 2, the master device 11 may optionally comprise the following elements to assist in accomplishing the aforesaid functions of the connection interface 111 and the processor 113: a resource manager 1131, a job manager 1133, an optimal resource module 1135 and a model manager 1137. Additionally, the slave device 13 may optionally comprise the following elements to assist in accomplishing the aforesaid functions of the connection interface 131 and the processor 133: a slave manager 1331, at least one container 1333, a model generator 1335, a job status collector 1337 and a metric file 1339.

Firstly, when the job 21 is received by the master device 11, the resource manager 1131 will activate the job manager 1133 and then pass the job 21 to the job manager 1133 for processing. At the same time, the resource manager 1131 may acquire from the slave manager 1331 device information 22 thereof and then transmit the device information 22 to the job manager 1133. Then, the job manager 1133 transmits the job 21 and the device information 22 to the optimal resource module 1135. After having acquired the job 21 and the device information 22, the optimal resource module 1135 will acquire the resource feature model 23 from the model manager 1137 according to the job 21 and the device information 22. At the same time, the optimal resource module 1135 can store the job information 25 corresponding to the job 21 into the distribution file system 15. Then, the optimal resource module 1135 will estimate the container configuration parameter 24 of the slave device 13 according to the resource feature model 23, and then transmit the container configuration parameter 24 to the job manager 1133. Finally, the job manager 1133 transmits the container configuration parameter 24 to the resource manager 1131.

After having acquired the container configuration parameter 24, the resource manager 1131 transmits the container configuration parameter 24 to the slave manager 1331, and assigns the job 21 to the slave manager 1331. The slave manager 1331 generates at least one container 1333 to compute the job 21 (or the tasks corresponding to the job 21 assigned by the resource manager 1131) according to the container configuration parameter 24. The slave manager 1331 can determine the number of containers 1333 as well as the CPU specification and the memory specification of the containers 1333 according to the container configuration parameter 24. During the process of computing the job 21 (or the tasks corresponding to the job 21 assigned by the resource manager 1131) by the containers 1333, the job status collector 1337 collects a job status at which the containers 1333 compute the job 21 (or the tasks corresponding to the job 21 assigned by the resource manager 1131), and stores the status information 26 corresponding to the job status into the metric file 1339. The status information 26 may comprise but is not limited to the following: the CPU consumption and the memory consumption of each of the containers 1333.

After the job 21 (or the tasks corresponding to the job 21 assigned by the resource manager 1131) is computed by the container 1333, the model generator 1335 can create or update the resource feature model 23 according to the job information 25 corresponding to the job 21 (or the tasks corresponding to the job 21 assigned by the resource manager 1131) and the metric file 1339. For example, the model generator 1335 can use a support vector regression module generator to create the resource feature model 23 according to the job information 25 and the metric file 1339. The model generator 1335 can acquire the job information 25 from the distribution file system 15 and/or from the slave manager 1331. The job information 25 acquired from the distribution file system 15 may include but is not limited to the following: the data size, the Map/Reduce dissembling number and etc. The job information 25 acquired from the slave manager 1331 may comprise but is not limited to the following: information about Map/Reduce computation by each of the containers and etc. The information acquired from the metric file 1339 may comprise but is not limited to the following: the status information 26, information about the hardware performance during the computing process and etc.

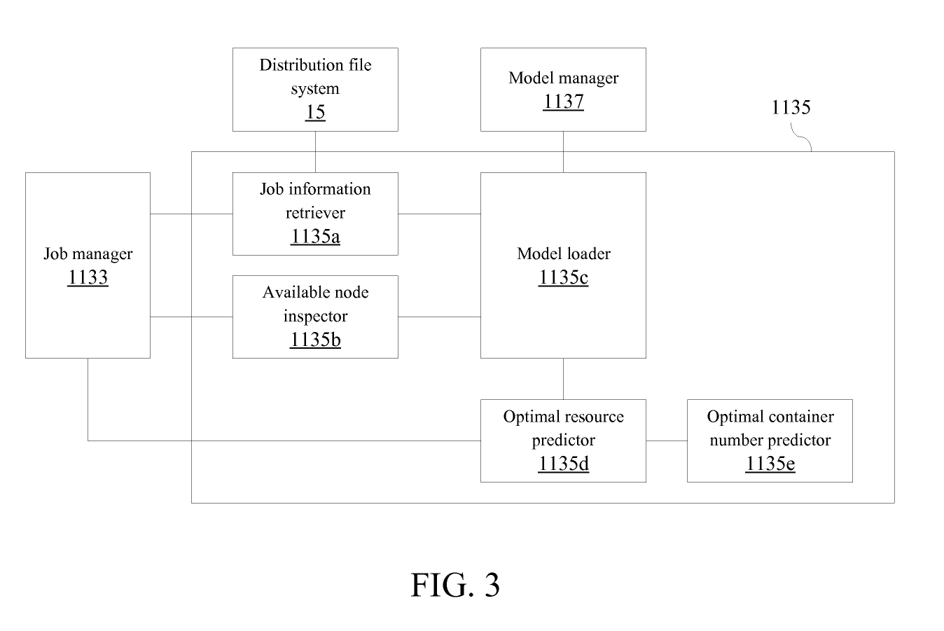

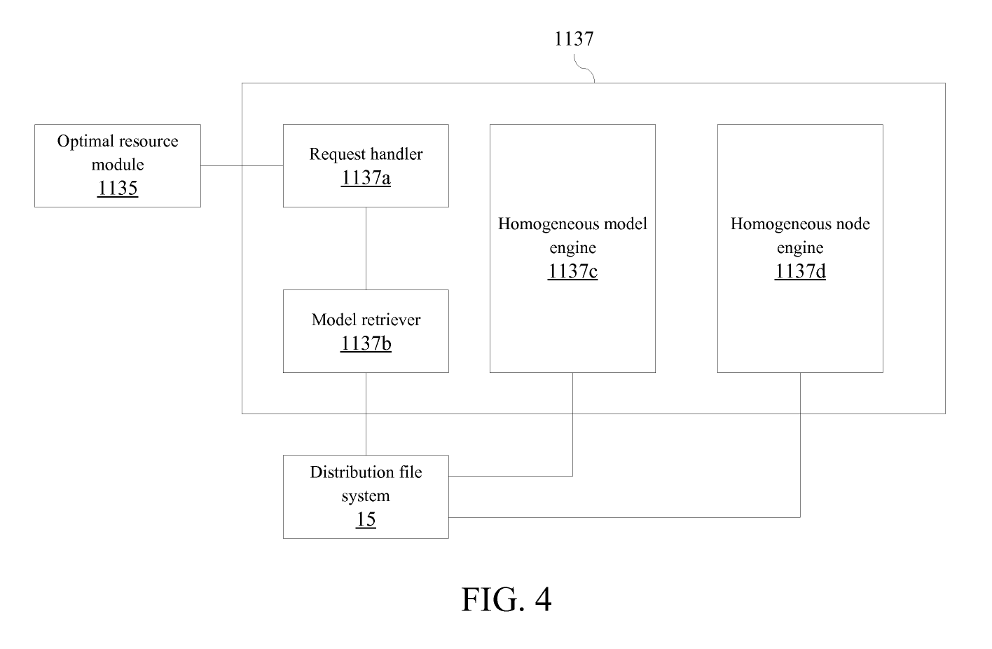

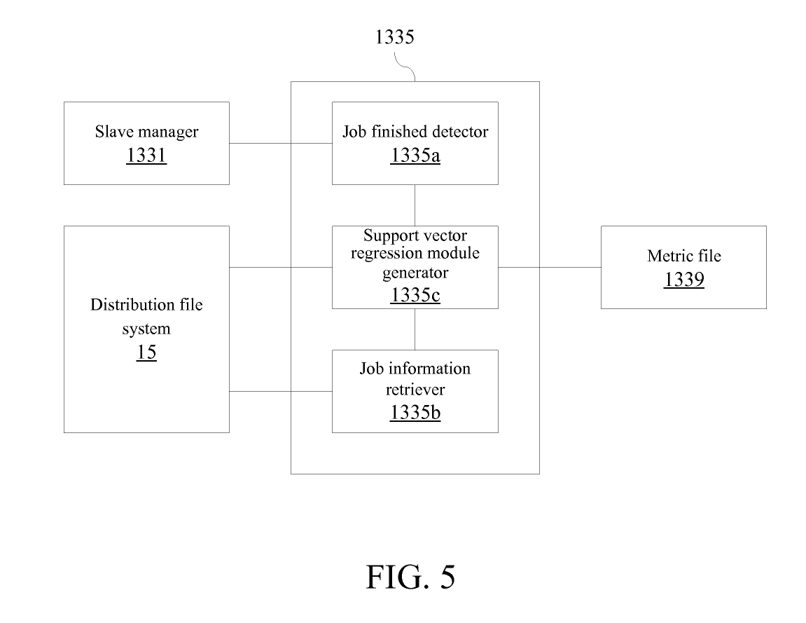

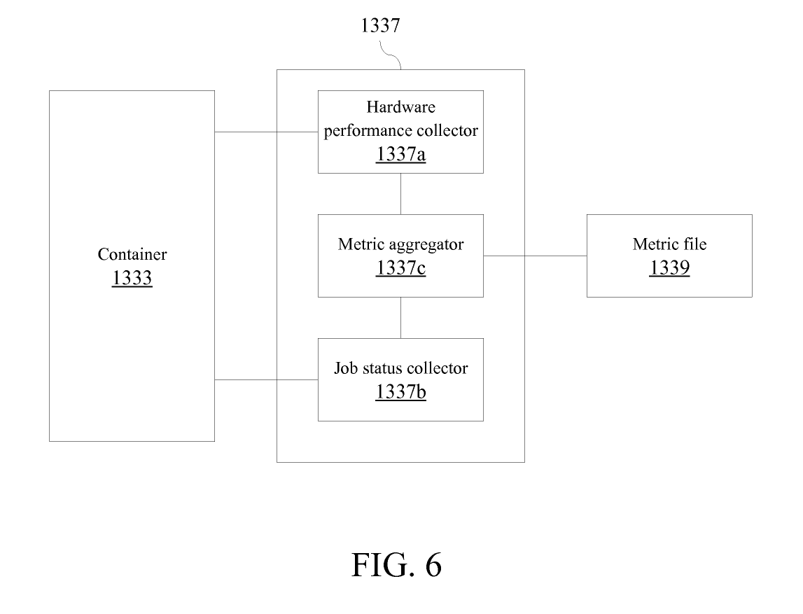

FIG. 3, FIG. 4, FIG. 5 and FIG. 6 are schematic views illustrating the specific operations of the optimal resource module 1135, the model manager 1137, the model generator 1335 and the job status collector 1337 respectively. However, in other embodiments of the present invention, the operations of the optimal resource module 1135, the model manager 1137, the model generator 1335 and the job status collector 1337 shown in FIG. 2 may not need to completely follow what shown in FIGS. 3-6, but may be adjusted, altered, and/or replaced appropriately without departing from the spirits of the present invention.

As shown in FIG. 3, the optimal resource module 1135 may comprise a job information retriever 1135a, an available node inspector 1135b, a model loader 1135c, an optimal resource predictor 1135d, and an optimal container number predictor 1135e. After the job 21 is acquired by the job manager 1133, the job information retriever 1135a will receive the following data: the job name (e.g., an algorithm name), the input data size and all the Map/Reduce tasks. The input data size and all the Map/Reduce tasks are then stored into the distribution file system 15. When an available node (i.e., an available slave device 13) appears in the cluster computing system 1, the name of the node will be received by the available node inspector 1135b. Then, the model loader 1135c will search for the corresponding resource feature model 23 in the model manager 1137 according to the job name and the name of the node.

The optimal resource predictor 1135d can predict a CPU specification and a memory specification of a container corresponding to the node according to the resource feature model 23, and the optimal container number predictor 1135e can estimate the container number of the node according to the CPU specification and the memory specification. Therefore, through the aforesaid operations of the optimal resource predictor 1135d and the optimal container number predictor 1135e, the container configuration parameter 24 of the node can be estimated by the optimal resource module 1135 and then transmitted to the job manager 1133.

As shown in FIG. 4, the model manager 1137 may comprise a request handler 1137a, a model retriever 1137b, a homogeneous model engine 1137c and a homogeneous node engine 1137d. When the optimal resource module 1135 makes a request for searching for the resource feature model 23, the request handler 1137a will select the resource feature model 23 from the plurality of resource feature model samples stored in the distribution file system 15 or other sources according to the job name and the node name transmitted by the optimal resource module 1135. For example, the request handler 1137a may select one of a corresponding resource feature model, a similar resource feature model and a preset resource feature model as the resource feature model 23.

The homogeneous model engine 1137c may comprise a model information retriever (not shown), a model grouper (not shown) and a group decider (not shown). When the number of the resource feature model samples is too large (e.g., larger than a threshold value), the model information retriever will retrieve various information about each of the resource feature model samples, and then the model grouper will classify the resource feature model samples into a plurality of groups according to such information. For example, the model grouper may use the K-means algorithm to classify the resource feature model samples into a plurality of groups. Additionally, optionally, the model grouper may select a resource feature model sample from each of the groups as a resource feature model representative, and the request manager 1137a may select the resource feature model 23 from the resource feature model representatives according to the job name and the node name transmitted by the optimal resource module 1135. When a new resource feature model sample appears, the group decider will add the new resource feature model sample into the most appropriate group according to the various information of the new resource feature model sample.

The homogeneous node engine 1137d may comprise a node information retriever (not shown), a node grouper (not shown), a group decider (not shown) and a group model generator (not shown). When the number of the nodes (i.e., the slave device 13) is too large (e.g., larger than a threshold value), the node information retriever will retrieve various information (e.g., the hardware information) of each of the nodes, and the node grouper will then classify the nodes into a plurality of groups according to such information. For example, the node grouper may use the K-means algorithm to classify the nodes into the plurality of groups. When a new node appears, the group decider will add the new node into the most appropriate group according to the various information of the new node. Additionally, the group model generator will retrieve the training data in the group to which the new node belongs, create the resource feature model 23 for the new node by means of a support vector regression module generator, and store the resource feature model 23 into the distribution file system 15. In other embodiments, the homogeneous node engine 1137d may be combined with the homogeneous model engine 1137c.

As shown in FIG. 5, the model generator 1335 may comprise a job finished detector 1335a, a job information retriever 1335b and a support vector regression model generator 1335c. The job finished detector 1335a is configured to detect whether the job 21 (or the tasks corresponding to the job 21 assigned by the resource manager 1131) is finished or not. After the job 21 (or the tasks corresponding to the job 21 assigned by the resource manager 1131) is finished, the job information retriever 1335b acquires the job information 25 corresponding to the job 21 from the distribution file system 15, and acquire the various information (including the status information 26) from the metric file 1339. Then, the support vector regression module generator 1335c creates the resource feature model 23 and stores it into the distribution file system 15 according to the job information 25 and the various information of the metric file 1339.

The input data of the support vector regression module generator 1335c may comprise but is not limited to: the size of the historical job data set from the job information retriever 1335b, the total number of Map tasks of the historical job from the job information retriever 1335b, the total number of Reduce tasks of the historical job from the job information retriever 1335b, the number of Map containers assigned to the node in the historical job, the number of Reduce containers assigned to the node in the historical job, the CPU usage of a single task in the historical job, the memory usage of a single task in the historical job and etc. The CPU usage of a single task in the historical job is equal to the CPU usage divided by the number of Maps and Reduces that are in operation, while the memory usage of a single task in the historical job is equal to the memory usage divided by the number of Maps and Reduces that are in operation. The various information of the job information 25 and the metric file 1339 may comprise but is not limited to the following: the input data size, assigned Map tasks, assigned Reduce tasks, assigned Map slots, assigned Reduce slots, average CPU usage per task, average memory usage per task and etc.

As shown in FIG. 6, the job status collector 1337 may comprise a hardware performance collector 1337a, a job status collector 1337b and a metric aggregator 1337c. The hardware performance collector 1337a is configured to collect information about the CPU usage and the memory usage in the container 1333, while the job status collector 1337b is configured to collect information about the assigned Map slots, the assigned Reduce slots, the Map tasks that are being computed and the Reduce tasks that are being computed. The metric aggregator 1337c is configured to aggregate the information collected by the hardware performance collector 1337a and the job status collector 1337b into the metric file 1339. The information aggregated into the metric file 1339 comprises but is not limited to the following: the assigned Map slots, assigned Reduce slots, average CPU usage per task, average memory usage per task and etc. The average CPU usage per task is equal to the CPU usage divided by the combination of the number of Map tasks that are being computed and the number of reduced tasks that are being computed, while the average memory usage per task is equal to the memory usage divided by the combination of the number of Map tasks that are being computed and the number of reduced tasks that are being operated.

The optimal resource module 1135, the model manager 1137, the model generator 1135 and the job status collector 1337 as illustrated in FIGS. 3˜6 respectively are only provided as an exemplary example of this embodiment but not intended to limit the present invention.

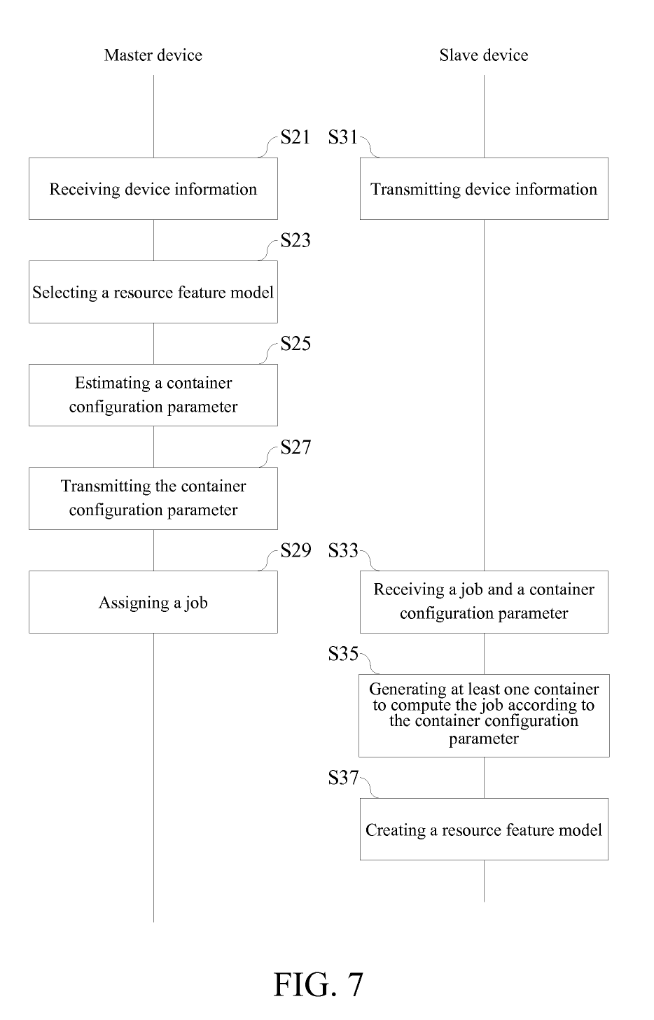

Another embodiment of the present invention (briefly called “a second embodiment”) is a computing method for a master device and a slave device in a cluster computing system. The cluster computing system, the master device and the slave device may be considered as the cluster computing system 1, the master device 11 and the slave device 13 of the aforesaid embodiment respectively. FIG. 7 is a schematic view illustrating a computing method for a master device and a slave device in a cluster computing system.

For a master device, the computing method of this embodiment comprises the following steps: a step S21 of receiving device information of the slave device by a processor of the master device; a step S23 of selecting a resource feature model for the slave device according to the device information and a job by the processor of the master device; a step S25 of estimating a container configuration parameter of the slave device according to the resource feature model by the processor of the master device; a step S27 of transmitting the container configuration parameter to the slave device by the processor of the master device; and a step S29 of assigning the job to the slave device by the processor of the master device. The order in which the steps S21˜S29 are presented is not intended to limit the present invention, and can be adjusted appropriately without departing from the spirits of the present invention.

In an exemplary example of the computing method, the cluster computing system further comprises a distribution file system, which is shared by the master device and the slave device. The step S23 comprises the following step: selecting the resource feature model for the slave device from the distribution file system according to the device information and the job by the processor of the master device. In this example, the computing method may optionally further comprise the following step: storing job information corresponding to the job into the distribution file system by the processor of the master device.

In an exemplary example of the computing method, the resource feature model comprises a CPU feature model and a memory feature model, the container configuration parameter comprises a container number and a container specification. The container specification comprises a CPU specification and a memory specification.

In an exemplary example of the computing method, the step S23 comprises the following step: selecting one of a corresponding resource feature model, a similar resource feature model and a preset resource feature model as the resource feature model for the slave device by the processor of the master device according to the device information and the job. The corresponding resource feature model is selected with a priority over the similar resource feature model, and the similar resource feature model is selected with a priority over the preset resource feature model.

In an exemplary example of the computing method, the step S23 comprises the following steps: classifying a plurality of resource feature model samples into a plurality of groups by the processor of the master device; selecting a resource feature model sample from each of the groups as a resource feature model representative by the processor of the master device; and selecting the resource feature model for the slave device from the resource feature model representatives by the processor of the master device according to the device information and the job.

For the slave device, the computing method of this embodiment comprises the following steps: a step S31 of transmitting device information to the master device by the processor of the slave device; a step S33 of receiving a job and a container configuration parameter that are assigned by the master device from the master device by the processor of the slave device; a step S35 of generating at least one container to compute the job according to the container configuration parameter by the processor of the slave device; and a step S37 of creating a resource feature model by the processor of the slave device according to job information corresponding to the job and a metric file. The order in which the steps S31˜S37 are presented is not intended to limit the present invention, and can be adjusted appropriately without departing from the spirits of the present invention.

In an exemplary example of the computing method, the cluster computing system further comprises a distribution file system, which is shared by the master device and the slave device. The step S37 comprises the following step: creating the resource feature model in the distribution file system by the processor of the slave device according to the job information and the metric file. In this example, the computing method may optionally further comprise the following step: acquiring the job information from the distribution file system by the processor of the slave device.

In an exemplary example of the computing method, the computing method further comprises the following step: collecting a job status at which the container computes the job, and storing status information corresponding to the job status into the metric file by the processor of the slave device.

In an exemplary example of the computing method, the resource feature model comprises a CPU feature model and a memory feature model, the container configuration parameter comprises a container number and a container specification, and the container specification comprises a CPU specification and a memory specification.

In an exemplary example of the computing method, the step S37 comprises the following step: using a support vector regression module generator by the processor to create a resource feature model according to the job information and the metric file.

The computing method of the second embodiment essentially comprises all the steps corresponding to the operations of the master device 11 and the slave device 13 of the previous embodiment. Those of ordinary skill in the art of the present invention can directly understand the computing methods that are not described in the second embodiment according to the related disclosure of the previous embodiment.

In addition to what has been described above, the computing method of the second embodiment further comprises the steps corresponding to other operations of the master device 11 and the slave device 13 of the previous embodiment. The method in which the computing methods of the second embodiment execute these corresponding steps that are not disclosed in the second embodiment can be readily appreciated by those of ordinary skill in the art of the present invention based on the related disclosure of the first embodiment, and thus will not be further described herein.

According to the above descriptions, the present invention provides a master device, a slave device and computing methods thereof for a cluster computing system. According to the present invention, a master device receives device information transmitted by each of the slave devices, selects a resource feature model for each of the slave devices according to the device information and a job, estimates a container configuration parameter of the corresponding slave device according to each of the resource feature models, transmits each of the container configuration parameters to the corresponding slave device, and assigns the job to the slave devices. According to the present invention, a slave device transmits device information thereof to a master device, receives from the master device a job and a container configuration parameter that are assigned by the master device, generates at least one container to compute the job according to the container configuration parameter, and creates a resource feature model according to job information corresponding to the job and a metric file.

Accordingly, the specification of the containers generated by the slave device of the present invention can be adjusted dynamically, so there would be no resource in waste due to different properties of different jobs. Furthermore, because the container specification is not fixed for each of the containers of the present invention, the number of containers of the slave device of the present invention can also be adjusted dynamically, so there would be no resource idling. Additionally, because the container specification and the number of the containers generated by the slave device of the present invention can be adjusted dynamically, improper allocation of resources will not occur even when a plurality of slave devices have different device performances.

The above disclosure is related to the detailed technical contents and inventive features thereof. Persons skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A master device for a cluster computing system, comprising:
a connection interface, being configured to connect with at least one slave device; and
a processor electrically connected to the connection interface, being configured to receive device information from the slave device, select a resource feature model for the slave device according to the device information and a job, estimate a container configuration parameter of the slave device according to the resource feature model, transmit the container configuration parameter to the slave device, and assign the job to the slave device.

2. The master device as claimed in claim 1, wherein the cluster computing system further comprises a distribution file system, the master device shares the distribution file system with the slave device, and the processor selects the resource feature model for the slave device from the distribution file system.

3. The master device as claimed in claim 2, wherein the processor further stores job information corresponding to the job into the distribution file system.

4. The master device as claimed in claim 1, wherein the resource feature model comprises a central processing unit (CPU) feature model and a memory feature model, the container configuration parameter comprises a container number and a container specification, and the container specification comprises a CPU specification and a memory specification.

5. The master device as claimed in claim 1, wherein the processor selects one of a corresponding resource feature model, a similar resource feature model and a preset resource feature model as the resource feature model, the corresponding resource feature model is selected with a priority over the similar resource feature model, and the similar resource feature model is selected with a priority over the preset resource feature model.

6. The master device as claimed in claim 1, wherein the processor further classifies a plurality of resource feature model samples into a plurality of groups, selects a resource feature model sample from each of the groups as a resource feature model representative, and selects the resource feature model for the slave device from the resource feature model representatives.

7. A slave device for a cluster computing system, comprising:
a connection interface, being configured to connect with a master device; and
a processor electrically connected to the connection interface, being configured to transmit device information to the master device, receive a job and a container configuration parameter that are assigned by the master device from the master device, generate at least one container to compute the job according to the container configuration parameter, and create a resource feature model according to job information corresponding to the job and a metric file.

8. The slave device as claimed in claim 7, wherein the cluster computing system further comprises a distribution file system, the master device shares the distribution file system with the slave device, and the processor creates the resource feature model in the distribution file system.

9. The slave device as claimed in claim 8, wherein the processor further acquires the job information from the distribution file system.

10. The slave device as claimed in claim 7, wherein the processor further collects a job status at which the container computes the job, and stores status information corresponding to the job status into the metric file.

11. The slave device as claimed in claim 7, wherein the resource feature model comprises a CPU feature model and a memory feature model, the container configuration parameter comprises a container number and a container specification, and the container specification comprises a CPU specification and a memory specification.

12. The slave device as claimed in claim 7, wherein the processor uses a support vector regression module generator to create a resource feature model according to the job information and the metric file.

13. A computing method for a master device in a cluster computing system, the master device comprising a connection interface and a processor, and the connection interface being configured to connect with at least one slave device, the computing method comprising:
(A) receiving device information of the slave device by the processor;
(B) selecting a resource feature model for the slave device according to the device information and a job by the processor;
(C) estimating a container configuration parameter of the slave device according to the resource feature model by the processor;
(D) transmitting the container configuration parameter to the slave device by the processor; and
(E) assigning the job to the slave device by the processor.

14. The computing method as claimed in claim 13, wherein the cluster computing system further comprises a distribution file system, the master device shares the distribution file system with the slave device, and the step (B) comprises: selecting the resource feature model for the slave device from the distribution file system according to the device information and the job by the processor.

15. The computing method as claimed in claim 14, further comprising (F) storing job information corresponding to the job into the distribution file system by the processor.

16. The computing method as claimed in claim 13, wherein the resource feature model comprises a CPU feature model and a memory feature model, the container configuration parameter comprises a container number and a container specification, and the container specification comprises a CPU specification and a memory specification.

17. The computing method as claimed in claim 13, wherein the step (B) comprises: selecting one of a corresponding resource feature model, a similar resource feature model and a preset resource feature model as the resource feature model for the slave device by the processor according to the device information and the job, wherein the corresponding resource feature model is selected with a priority over the similar resource feature model, and the similar resource feature model is selected with a priority over the preset resource feature model.

18. The computing method as claimed in claim 13, wherein the step (B) comprises: classifying a plurality of resource feature model samples into a plurality of groups by the processor; selecting a resource feature model sample from each of the groups as a resource feature model representative by the processor; and selecting the resource feature model for the slave device from the resource feature model representatives by the processor according to the device information and the job.

19. A computing method for a slave device in a cluster computing system, the slave device comprising a connection interface and a processor, and the connection interface being configured to connect with a master device, the computing method comprising:
(A) transmitting device information to the master device by the processor;
(B) receiving a job and a container configuration parameter that are assigned by the master device from the master device by the processor;
(C) generating at least one container to compute the job according to the container configuration parameter by the processor; and
(D) creating a resource feature model by the processor according to job information corresponding to the job and a metric file.

20. The computing method as claimed in claim 19, wherein the cluster computing system further comprises a distribution file system, the master device shares the distribution file system with the slave device, and the step (D) comprises: creating the resource feature model in the distribution file system by the processor according to the job information and the metric file.

21. The computing method as claimed in claim 20, further comprising (E) acquiring the job information from the distribution file system by the processor.

22. The computing method as claimed in claim 19, further comprising (F) collecting a job status at which the container computes the job, and storing status information corresponding to the job status into the metric file by the processor.

23. The computing method as claimed in claim 19, wherein the resource feature model comprises a CPU feature model and a memory feature model, the container configuration parameter comprises a container number and a container specification, and the container specification comprises a CPU specification and a memory specification.

24. The computing method as claimed in claim 19, wherein the step (D) comprises using a support vector regression module generator by the processor to create a resource feature model according to the job information and the metric file.
